(19) United States
(12) Patent Application Publication
(10) Pub. No.: US 2015/0153475 A1
(43) Pub. Date: Jun. 4, 2015

(54) SUBSURFACE MODELING SYSTEMS AND METHODS HAVING AUTOMATED EXTRAPOLATION OF INCOMPLETE HORIZONS

(71) Applicant: Artem M. Baranov, Houston, TX (US)

(72) Inventor: Artem M. Baranov, Houston, TX (US)

(73) Assignee: Chevron U.S.A. Inc., San Ramon, CA (US)

(21) Appl. No.: 14/086,363

(22) Filed: Nov. 21, 2013

(51) Int. Cl. G01V 99/00

(52) U.S. Cl. CPC G01V 99/00

(57) ABSTRACT

At least some of method and system embodiments extrapolate any given set of horizons to cover a specified area of interest in such a manner that the horizons are conformable to each other. An automated dual-extrapolation approach is employed, beginning with horizon extrapolations using a proportional method where possible, and following that with a horizon extrapolations using a thickness-based method. With proper selection of the extrapolation order, the set of horizons remains fully conformable. The process of deriving a structural 3D model from partial horizons in fields lacking field-wide reference horizons is facilitated, making it more feasible to fully model complex fields and correct errors in such models.

### BACKGROUND

Explorationists and developers of hydrocarbon and mineral reservoirs collect substantial amounts of information regarding subsurface structures of interest. Such information is often cast in the form of a model having two or three spatial dimensions (“model space”) to demonstrate the spatial dependence of the relevant subsurface formation properties. Due to the nature of geologic processes, such properties normally correspond to bedding layers that can be delineated by “horizons”, e.g., surfaces in a three dimensional model space. Visualization and analyses of the subsurface structures can be facilitated by mapping the horizons throughout the model space.

Unfortunately, much of the information for a region of interest tends to be somewhat localized, particularly in “heavy oil” fields having a discontinuous geology without a wide area seismic survey for data control and correlation. The information gathered by borehole logging tools is generally indicative of spatial property distributions only in the immediate vicinity of the boreholes, and cannot be readily krigged across those data gaps that often exist in down dip or water saturated sections. As a result, such fields are left with isolated patches of data that represent different horizons, making it difficult to extend all of the horizons over the whole region of interest.

To address this type of problem, some geomodelers might attempt to employ the concept of conformable surfaces to extrapolate the incomplete horizons to the limits of the model space (or to boundaries created by faults, basal surfaces, erosional surfaces, or other discontinuities). The conformable surface concept works in situations where at least some of the horizons exhibit a consistent visibility, enabling them to be mapped across relatively large areas to serve as a reference. The remaining horizons are then “conformed” to the reference horizons, meaning that the other horizons are largely parallel to the reference horizons and do not cross the reference horizon or each other. Some change in the thicknesses of the delineated layers is possible, but such changes are generally minimized. For example, where an incomplete horizon exists adjacent to a reference horizon, the distance between the two horizons is determined and used to extrapolate the incomplete horizon across the full extent of the reference horizon. Unfortunately, such extensive reference horizons are generally not present in the type of problem addressed here. With the patchwork of different horizons, the thickness-based extrapolations often lead to (undesirable) horizon crossings, which the modeler may try to address by manually adjusting the extrapolation or, where insufficient time exists, by entirely eliminating the problematic horizon. Both approaches are undesirable.

Other approaches exist, but may be limited for other reasons. For example, a proportional extrapolation can be employed in those regions where multiple reference horizons are available. (The ratio of distances from the horizon patch to the reference horizons is determined and used as the basis for the extrapolation.) The requirement for multiple overlapping reference horizons can be quite difficult to satisfy in the type of problem addressed here. Alternatively, implicit modeling approaches (such as volume based modeling technology that attempts to determine a geological deposition time for each point in the model space) can be employed. However, such models can be difficult to understand and hence difficult to correct if errors are made.

### BRIEF SUMMARY

Accordingly, there are disclosed in the drawings and the following description various subsurface modeling systems and methods having automated extrapolation of incomplete horizons. Certain disclosed embodiments include a computer-implemented subsurface modeling method that includes: obtaining a set of conformable horizons in a model space with one or more of the horizons being incomplete; automatically performing proportional extrapolation for each of the horizons having at least one edge between two of the horizons; and, once no edges can be found between two of the horizons, automatically performing thickness extrapolation for each of the horizons having at least one edge inside a boundary of an adjacent one of the horizons. The resulting set of conformable horizons can be displayed on a computer monitor. In some variations, the displaying may be done after the set of conformable horizons are terminated with at least one non-conformable horizon such as a basal horizon, a discontinuous horizon, or an erosional horizon, particularly where the set of conformable horizons is one of multiple such sets. In this case, the method may further include: performing automatic proportional and thickness extrapolation for each such set individually; employing one or more non-conformable horizons to terminate the sets along one or more shared boundaries; and combining the terminated sets in one model space. An edge may be determined to be between two horizons if vertical lines extending in both directions from the edge each intersect one of the two horizons, or alternatively, if lines extending from the edge in both directions normal to the given horizon each intersect one of the two horizons. An edge may be determined to be inside a boundary of an adjacent horizon if a vertical line extending in either direction from the edge intersects the adjacent horizon, or alternatively, if a line extending from the edge in a direction normal to the given horizon intersects the adjacent horizon. The set of conformable horizons may be obtained in an ordered sequence, so that performing the proportional extrapolation might include iterating through the sequence and performing the thickness extrapolation would include a separate iteration through the sequence.

Other disclosed embodiments include a subsurface modeling system that includes: a memory having subhorizon modeling software; and one or more processors coupled to the memory to execute the software. The software causes the one or more processors to carry out automatic operations that include: obtaining a set of conformable horizons in a model space with one or more of the horizons being incomplete; automatically performing proportional extrapolation for each of the horizons having at least one edge between two of the horizons; and, once no edges can be found between two of the horizons, automatically performing thickness extrapolation for each of the horizons having at least one edge inside a boundary of an adjacent one of the horizons. The resulting set of conformable horizons can be displayed on a computer monitor. In some variations, the displaying may be done after the set of conformable horizons are terminated with at least one non-conformable horizon such as a basal horizon, a discontinuous horizon, or an erosional horizon, particularly where the set of conformable horizons is one of multiple such sets. In this case, the method may further include: performing automatic proportional and thickness extrapolation for each such set individually; employing one or more non-conformable horizons to terminate the sets along one or more shared boundaries; and combining the terminated sets in one model space. An edge may be determined to be between two horizons if vertical lines extending in both directions from the edge each intersect one of the two horizons, or alternatively, if lines extending from the edge in both directions normal to the given horizon each intersect one of the two horizons. An edge may be determined to be inside a boundary of an adjacent horizon if a vertical line extending in either direction from the edge intersects the adjacent horizon, or alternatively, if a line extending from the edge in a direction normal to the given horizon intersects the adjacent horizon. The set of conformable horizons may be obtained in an ordered sequence, so that performing the proportional extrapolation might include iterating through the sequence and performing the thickness extrapolation would include a separate iteration through the sequence.

### BRIEF DESCRIPTION OF THE DRAWINGS

FIG. 1 is a map view of an illustrative region of interest.

FIG. 2 shows a geomodeler employing an illustrative modeling system.

FIG. 3 is a perspective view of an illustrative set of incomplete horizons.

FIG. 4A shows illustrative horizons in a two dimensional model space.

FIG. 4B shows multiple sets of conformable horizons bounded by non-conformable horizons.

FIG. 4C shows an evenly distributed sampling of horizon information.

FIG. 5A shows the depth as a function of position for a reference horizon and an incomplete horizon as used in an embodiment of thickness-based extrapolation.

FIG. 5B illustrates the thickness of the layer bounded by the two horizons as plotted as a function of position as used in an embodiment of thickness-based extrapolation.

FIG. 5C illustrates a plot of the depth as a function of position for reference horizons as well as an incomplete horizon as used in an embodiment of proportional-based extrapolation.

FIG. 5D illustrates the distance between the two reference horizons as plotted as a function of position as used in an embodiment of proportional-based extrapolation

FIG. 6 is a flow diagram of an illustrative extrapolation method.

FIG. 7A illustrates an initial set of incomplete conformable horizons.

FIG. 7B illustrates a resulting set of fully extrapolated horizons resulting from the sole application of thickness-based extrapolations.

FIG. 7C illustrates the initial extrapolations of the horizons.

FIG. 7D illustrates extrapolation of the second lowermost horizon.

FIG. 7E illustrates extrapolation of the middle horizon.

FIG. 7F illustrates extrapolation of the fourth lowermost horizon.

FIG. 7G illustrates extrapolation of the third lowermost horizon.

FIG. 7H illustrates extrapolation of the second lowermost horizon.

FIG. 7I illustrates extrapolation of the lowermost horizon.

FIG. 7J illustrates extrapolation of the topmost horizon, using an adjacent horizon as a reference horizon.

FIG. 8A is a perspective view of partially extrapolated horizons.

FIG. 8B is a perspective view of fully extrapolated horizons.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

At least some of the disclosed methods and systems extrapolate any given set of horizons to cover a specified area of interest in such a manner that the horizons are conformable to each other. A dual-extrapolation approach is employed, beginning with horizon extrapolations using a proportional method where possible, and following that with a horizon extrapolations using a thickness-based method. The proportional method (also known as “surface morphing”) fills any gaps that are controlled both by underlying and overlying horizons. As a result the horizon being extended is controlled by the adjacent horizons above and below it. With proper selection of the extrapolation order, the set of horizons remains fully conformable. A thickness-based extrapolation (such as an isopach or isochore extrapolation) can then be applied. Again the extrapolation is applied in an order that ensures conformal behavior of the fully extrapolated horizons. It is expected that the disclosed methods and systems may dramatically facilitate the process of deriving a structural 3D model from partial horizons in fields lacking field-wide reference horizons, making it more feasible to fully model complex fields and correct errors in such models.

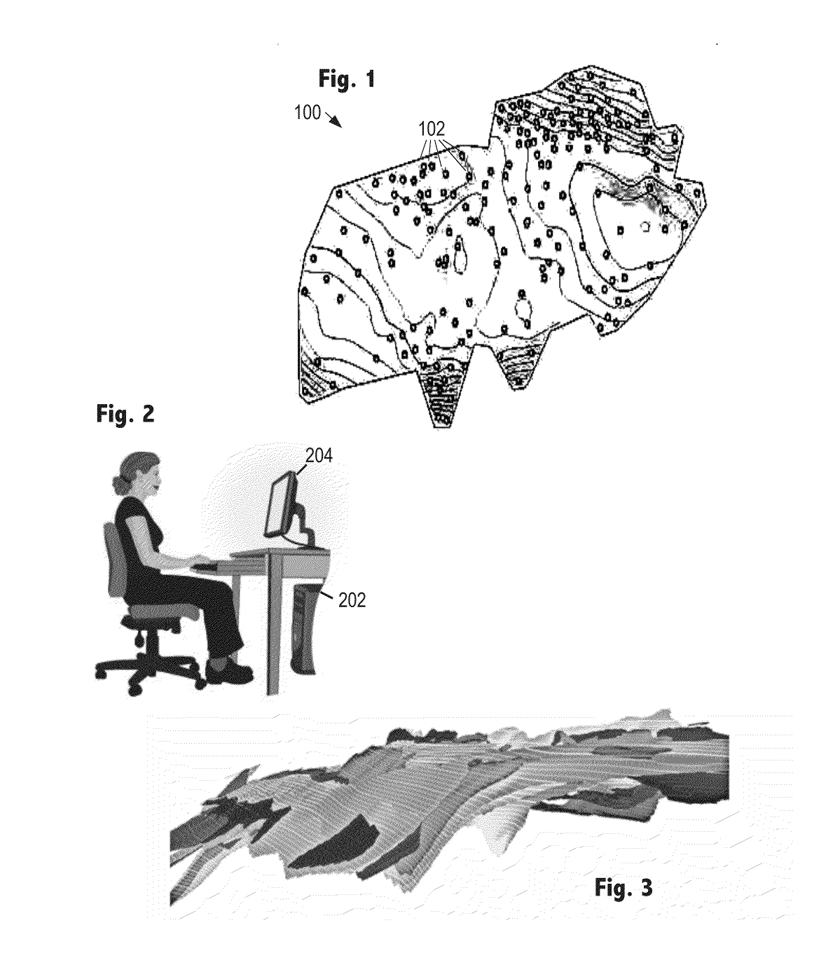

FIG. 1 is a map view of an illustrative region of interest 100, having multiple wells 102. A shown in FIG. 2, a geomodeler employs a subsurface modeling system 202 to view and analyze horizons in a model space on display 204. System 202 may employ geomodeling software from Paradigm, Schlumberger, or other providers, to extract such horizons and employ them for modeling the behavior of the reservoir in response to various drilling and field development proposals. System 202 is illustrated as a computer having processors that execute software. The software resides in memory and causes the processors to obtain, process, and output information representing the subsurface structures in the region of interest. Some of the software packages may provide for user-authored scripts, workflows, or other programs for providing an automated sequence of operations for processing an input data set. For example, Schlumberger's Petrel software includes a Process Manager that enables users to author workflows. Paradigm's GOCAD software supports the use of TCL (“Tool Command Language”) or CLI (“Command Language Interface”). Both packages support the use of plug-ins that can be authored in more traditional programming languages such as C++ or C#.

However, the region of interest may have a highly non-uniform distribution of wells and/or a complex geology. As a result, the horizons derived from the available data may be highly localized. FIG. 3 is a perspective view of an illustrative set of horizons that might be obtained from the hypothetical field of FIG. 1. Taken collectively, the horizons provide decent coverage of the region of interest, but individually each horizon covers only a small fraction of the model space. For adequate simulation of the field's anticipated behavior, it may be preferred to have a structural 3D model with horizons that fully cover the model space.

For explanatory purposes, we turn now from a 3D model space to a 2D model space. (The 2D space can be viewed as a vertical cross-section of the 3D space.) However, the disclosed principles are equally applicable to both 2D and 3D model spaces.

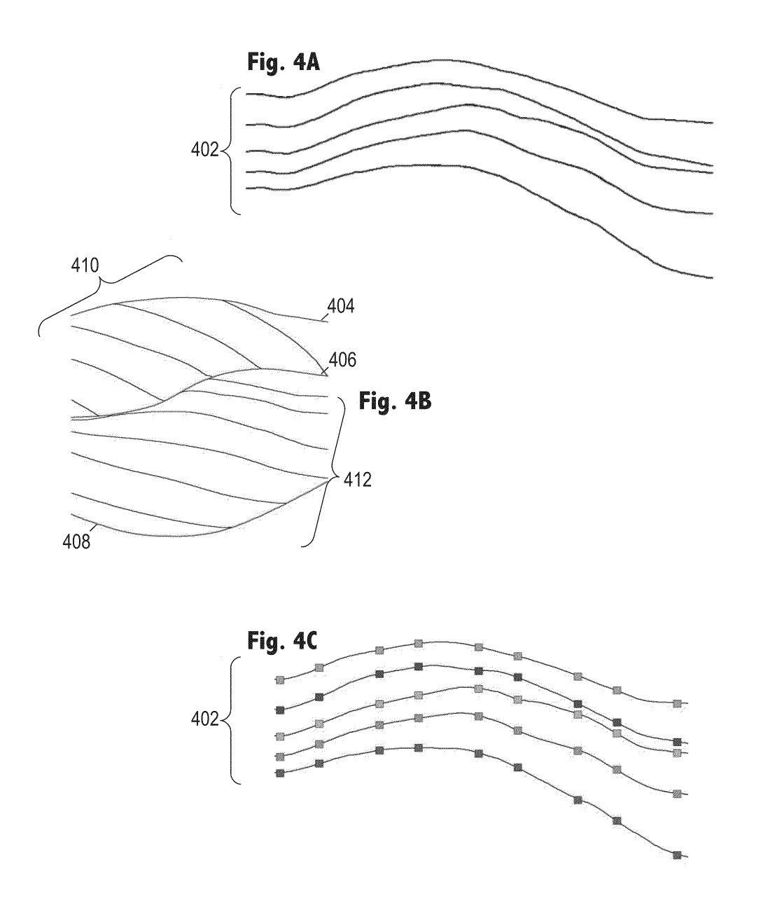

FIG. 4A shows a desirable structural 3D model, in that each of the horizons in the set 402 fully spans the width of the model space. Note that the set 402 is conformable. No sudden thickness changes in the layer or intersections in the horizons are present. Even in subsurface structures where such discontinuities are present, the set of horizons can be decomposed into conformable sets that are bounded with non-conformable horizons representing faults, basal surfaces, erosional surfaces, or other discontinuities. FIG. 4B provides an illustrative example, with three non-conformable horizons 404, 406, and 408, bounding two sets of conformable horizons. The set 410 includes the conformable horizons bounded by non-conformable horizons 404, 406. Set 412 includes the conformable horizons bounded by non-conformable horizons 406, 408. To extend the following disclosures to such situations, each set of conformable horizons is treated separately. The fully extrapolated sets of conformable horizons are trimmed as necessary to meet the relevant bounds, whether such bounds be non-conformable horizons or the edges of the model space. The trimmed horizons can then be assembled in a combined model space with the non-conformable horizons acting in much the same manner as the cuts in a jigsaw puzzle.

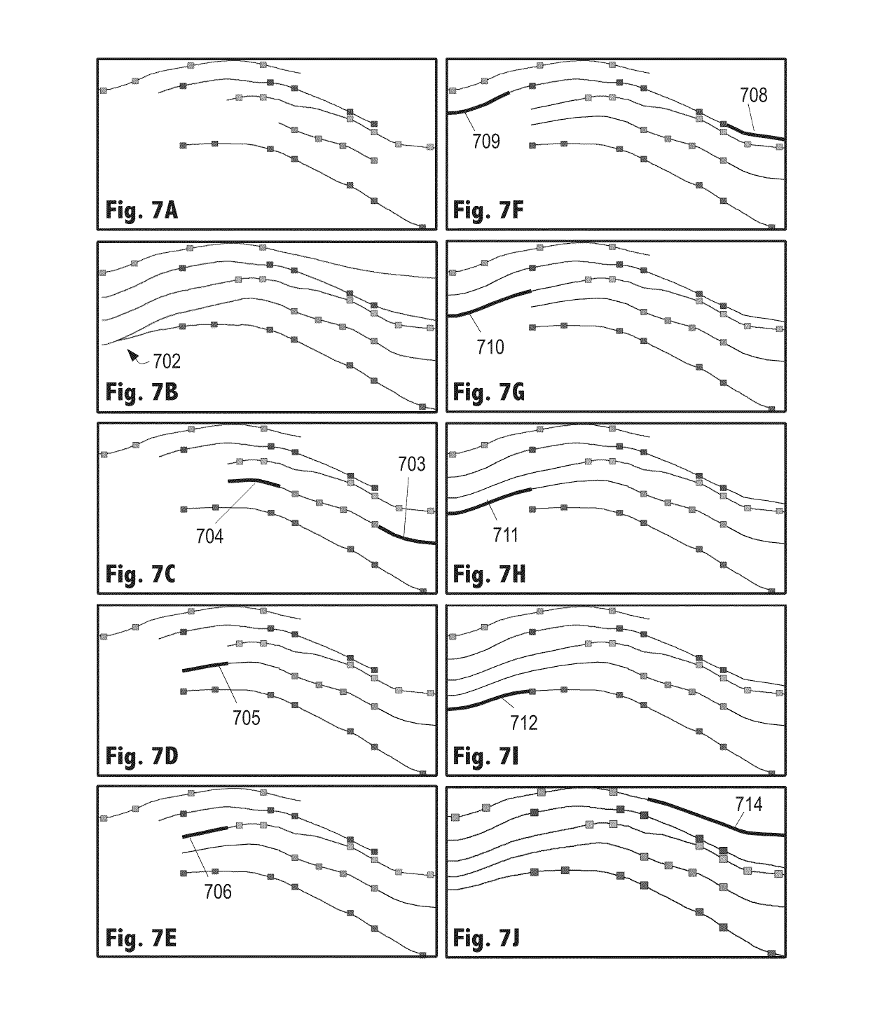

Focusing now on conformable surfaces, note that FIG. 4C shows the idealized situation in which each of the horizons is sampled in an evenly distributed manner that facilitates the mapping of the horizons across extent of the model space. Where evenly-spaced wells are employed with consistent data gathering techniques, each of the horizons is identifiable in each of the wells and extrapolation becomes a straightforward process. However, this idealized situation contrasts strongly with the problem at hand, which is represented by the much more challenging extrapolation used in FIG. 7A. In FIG. 7A, the wells are unevenly distributed and somewhat inconsistent about identifying horizon positions. Some of the horizons are identified in only small portions of the model space (e.g., the second horizon from the bottom). Nevertheless, the disclosed systems and methods are able to extrapolate a set of horizons largely equivalent to the idealized situation of FIG. 4C.

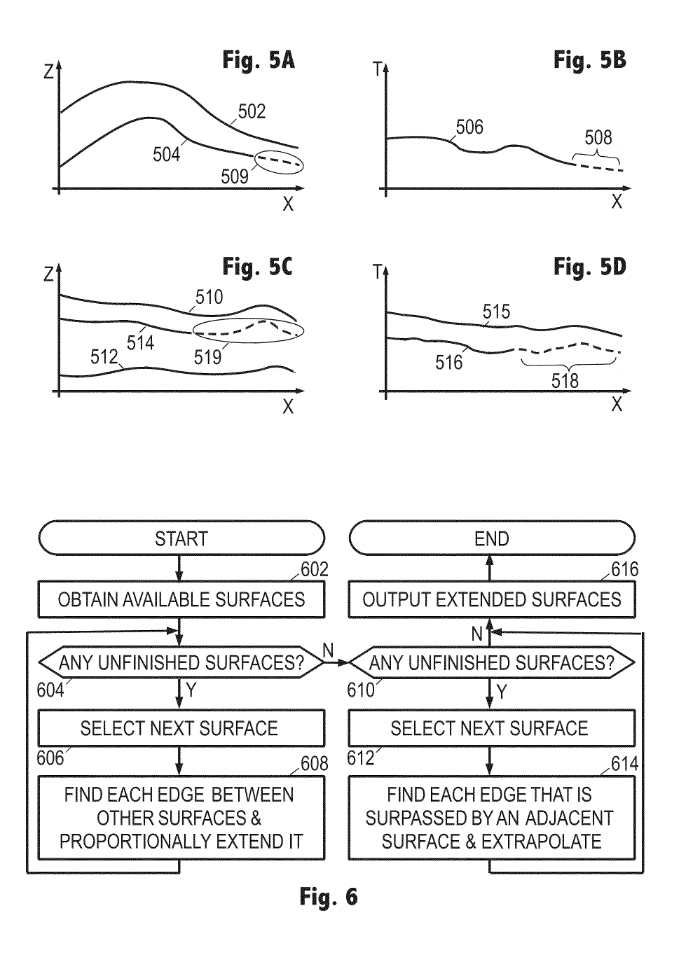

FIGS. 5A-5B illustrate a thickness-based extrapolation technique. FIG. 5A shows the depth as a function of position for a reference horizon 502 and an incomplete horizon 504. For thickness-based extrapolation, the thickness of the layer bounded by the two horizons is plotted as a function of position in FIG. 5B (curve 506). The thickness curve is then extrapolated. Standard linear, polynomial, or curve fitting extrapolation techniques can be employed for this extrapolation. The extrapolation 508 should preferably not extend into negative values, so an exponential decay may be employed where other extrapolations would yield negative values. The extrapolated thickness 508 is then combined with the reference horizon 502 to obtain the extrapolated horizon 509 extending from the edge of incomplete horizon 504.

FIGS. 5C-5D illustrate a proportional extrapolation technique, which is suitable for use with multiple reference horizons. FIG. 5C shows the depth as a function of position for reference horizons 510, 512, as well as incomplete horizon 514. The distance between the two reference horizons 510, 512, is plotted as a function of position in FIG. 5D (curve 515). Curve 516 represents the thickness of the layer between the incomplete horizon 514 and one of the reference horizons (512). The thickness curve 516 is extrapolated using the distance curve 515 as a guideline for the extrapolation. The thickness curve 516 may be evaluated relative to the distance curve, e.g., as a fraction or proportion of the distance curve. The proportion is then applied to the distance curve 515 to determine the thickness extrapolation 518, and this extrapolation is then combined with the reference curves 510, 512, to obtain the extrapolated horizon 519 from the edge of incomplete horizon 514.

The thickness measurement for both extrapolations can be the vertical distance between the horizons. Alternatively, the thickness can be measured stratigraphically, i.e., in a direction normal to one of the horizons. Both approaches are suitable.

With the foregoing foundation for understanding, FIG. 6 is a flow diagram of an illustrative subsurface modeling method that may be implemented in a commercially available software package (such as, e.g., Petrel or GOCAD) as an automated user script or workflow for a given set of input data; or as an integrated part of, or a plugin for, such a software package executed by a computer-implemented modeling system 202. It is contemplated that in at least some embodiments, the illustrated method is an automated tool that a software package user can invoke for automatic processing of any given set of horizons. Beginning in block 602, the system obtains the available horizons. The horizons may be provided as input or derived from available log information. In some embodiments, each horizon is expressed as a connected set of vertices in a model space. The illustrated method assumes that the horizons are a set of conformable surfaces ordered from top to bottom or vice versa. If this is not the case, the system may segregate the horizons into conformable sets with non-conformable horizons as bounds for each set.

The software causes the system to automatically execute two loops, iterating through the ordered set of conformable horizons in each loop. Blocks 604-608 form the first loop in which proportional extrapolation is employed. In block 604, the system determines whether the first loop has processed each of the horizons in the set. If not the system selects the next horizon to be processed in block 606. The iteration proceeds in order from top to bottom or vice versa. In block 608, the system determines whether any of the edges of the current horizon is between other horizons in the set. In other words, if a vertical line drawn in both directions from the edge intersects a horizon above and a horizon below, the edge is between other horizons. (The incidence of the line on an edge of another horizon does not qualify as an intersection. An intersection should be found only if the line contacts the interior region of the other horizon.) If so, the system uses the other horizons as reference horizons to proportionally extrapolate the current horizon. The extrapolation of an edge creates a new edge that should also be evaluated, as other horizons may exist to enable further extrapolation.

The determination of whether the current horizon is between other horizons can be structured as a nested loop within block 608. Recall that proportional extrapolation of the current horizon employs two reference horizons. Because the horizons are being treated in a systematic manner, one of these reference horizons will always be the “current horizon” from the previous iteration of loop. That is, if the iteration implemented in block 606 is from horizon 1 to horizon N, and the current horizon is horizon i, then horizon (i−1) is one of the reference horizons. The nested loop within block 608 considers each of the subsequent horizons (e.g., horizons (i+1) to N) as a possible second reference horizon for performing the proportional extrapolation. Once the present horizon has been extrapolated as much as possible, the system repeats the outer loop with the next horizon until each of the horizons has been processed, after which the system moves from block 604 to block 610.

Blocks 610-614 form the second loop, in which thickness-based extrapolation is employed. In block 610, the system determines whether all of the horizons have been fully evaluated, and if not, the system selects the next horizon in block 612. Note that here, a one-time unidirectional iteration through the sequence of horizons is unlikely to be sufficient, as the thickness-based extrapolation of any given horizon can necessitate a re-evaluation of the given horizon's adjacent horizons. Rather, a bi-directional iteration through the sequence may be preferred. For example, the system may iterate through the horizons from top to bottom and then again from bottom to top. Other iteration approaches may also be satisfactory.

In block 614, the system determines whether any of the edges of the current surface are surpassed by adjacent horizons (i.e., those horizons immediately preceding or following the given horizon in the ordered set). In other words, if a vertical line drawn in either direction from the edge intersects an adjacent horizon, the edge is surpassed by that horizon. If so, the system uses that adjacent horizon as a reference horizon for a thickness-based extrapolation. Note that each horizon may have multiple edges that can be extrapolated. The system works its way around the circumference. Once the horizon has been extended to the coverage limits provided by the adjacent surfaces, the system repeats the loop with the next horizon.

Once the iteration has been completed, the system outputs the set of extrapolated surfaces in block 616. At least some embodiments provide an interactive graphical interface that enables the user to view the resulting structural 3D model of the subsurface structure.

FIGS. 7A-7J provide a step by step example of the extrapolations that may be performed by the method of FIG. 6. FIG. 7A shows an initial set of incomplete conformable horizons. For contrast, FIG. 7B shows a resulting set of fully extrapolated horizons resulting from the sole application of thickness-based extrapolations. Note the undesirable intersection 702 that results. If the system implements the first loop in a bottom-to-top iteration, the first extrapolations are those shown in FIG. 7C. Proportional extrapolations 703, 704, employ the lowermost and the middle horizons as reference horizons. In FIG. 7D, the system determines that further extrapolation of the second lowermost horizon is achievable. Proportional extrapolation 705 employs the lowermost and fourth lowermost horizons as reference horizons.

In FIG. 7E, the system extrapolates the middle horizon. Proportional extrapolation 706 employs the second and fourth lowermost horizons as reference horizons. No further proportional extrapolations can be achieved, so the first loop concludes without further changes. Assuming that the second loop is iterated in a top-to-bottom-to-top order, the system next extrapolates the fourth lowermost horizon as shown in FIG. 7F. Thickness-based extrapolation 708 employs the third-lowermost horizon as a reference horizon. Thickness-based extrapolation 709 employs the topmost horizon as the reference horizon. In FIG. 7G, the third lowermost horizon is extrapolated. Thickness-based extrapolation 710 employs the fourth lowermost horizon as a reference horizon. In FIG. 7H, the system extrapolates the second lowermost horizon. Thickness-based extrapolation 711 employs the third lowermost horizon as a reference horizon. In FIG. 7I, the system extrapolates the lowermost horizon. Thickness-based extrapolation 712 employs the second lowermost horizon as a reference horizon.

In the reverse iteration, no further extrapolations are needed until the uppermost horizon is reached. In FIG. 7J, the system extrapolates the topmost horizon, using the adjacent horizon as a reference horizon. At this point, each of the horizons in the set has been fully extrapolated.

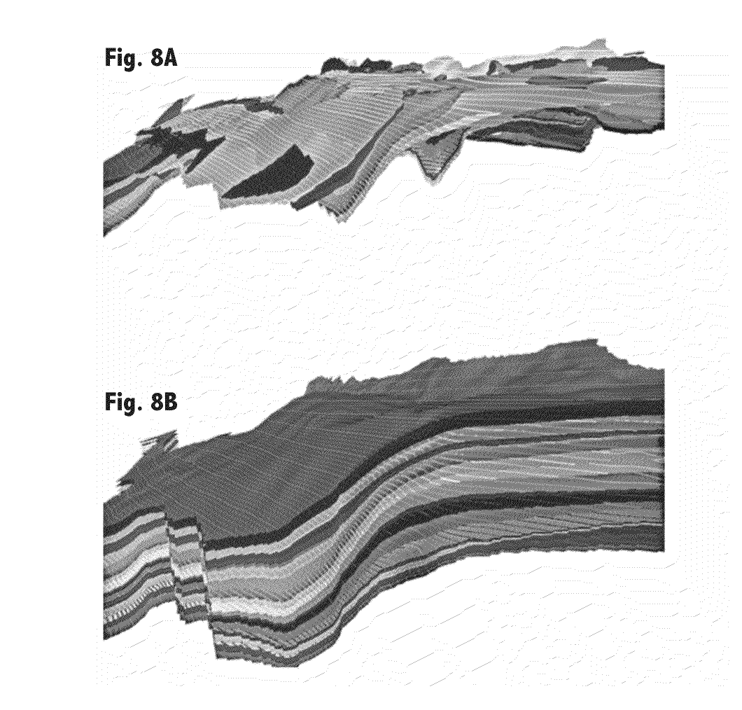

Similar processing can be applied to the horizons of FIG. 3. FIG. 8A shows these horizons as they appear at the completion of the proportional extrapolation stage, and FIG. 8B shows the fully extrapolated set of horizons.

Numerous variations and modifications will become apparent to those skilled in the art once the above disclosure is fully appreciated. It is intended that the following claims be interpreted to embrace all such variations and modifications.

What is claimed is:

1. A computer-implemented subsurface modeling method that comprises:
obtaining a set of conformable horizons in a model space, one or more of said horizons being incomplete;
automatically performing proportional extrapolation for each of said horizons having at least one edge between two of said horizons;
once no edges can be found between two of said horizons, automatically performing thickness extrapolation for each of said horizons having at least one edge inside a boundary of an adjacent one of said horizons; and
displaying the set of conformable horizons on a computer monitor.

2. The computer-implemented method of claim 1, further comprising:
once no more edges can be found inside a boundary of an adjacent horizon, terminating the set of conformable horizons with at least one non-conformable horizon.

3. The computer-implemented method of claim 2, wherein the at least one non-conformable horizon is a type in a set consisting of a basal horizon, a discontinuous horizon, and an erosional horizon.

4. The computer-implemented method of claim 2, wherein said set of conformable horizons is one of multiple such sets, and wherein the method further comprises:
performing automatic proportional and thickness extrapolation for each such set individually;
employing one or more non-conformable horizons to terminate the sets along one or more shared boundaries;
combining the terminated sets in one model space.

5. The computer-implemented method of claim 1, wherein an edge is determined to be between two horizons if vertical lines extending in both directions from the edge each intersect one of the two horizons.

6. The computer-implemented method of claim 5, wherein an edge is determined to be inside a boundary of an adjacent horizon if a vertical line extending in either direction from the edge intersects the adjacent horizon.

7. The computer-implemented method of claim 1, wherein an edge of a given horizon is determined to be between two horizons if lines extending from the edge in both directions normal to the given horizon each intersect one of the two horizons.

8. The computer-implemented method of claim 7, wherein an edge of a given horizon is determined to be inside a boundary of an adjacent horizon if a line extending from the edge in a direction normal to the given horizon intersects the adjacent horizon.

9. The computer-implemented method of claim 1, wherein the set of conformable horizons is an ordered sequence, wherein said performing proportional extrapolation includes iterating through the sequence, and wherein said performing thickness extrapolation includes a separate iteration through the sequence.

10. A subsurface modeling system that comprises:
a memory having subhorizon modeling software; and
one or more processors coupled to the memory to execute the software, causing the one or more processors to carry out automatic operations including:
obtaining a set of conformable horizons in a model space, one or more of said horizons being incomplete;
performing proportional extrapolation for each of said horizons having at least one edge between two of said horizons;
once no edges can be found between two of said horizons, performing thickness extrapolation for each of said horizons having at least one edge inside a boundary of an adjacent one of said horizons; and
displaying the set of conformable horizons.

11. The system of claim 10, wherein the automatic operations further include:
once no more edges can be found inside a boundary of an adjacent horizon, terminating the set of conformable horizons with at least one non-conformable horizon.

12. The system of claim 11, wherein the at least one non-conformable horizon is a type in a set consisting of a basal horizon, a discontinuous horizon, and an erosional horizon.

13. The system of claim 11, wherein said set of conformable horizons is one of multiple such sets, and wherein the automatic operations further include:
performing proportional and thickness extrapolation for each such set individually;
employing one or more non-conformable horizons to terminate the sets along one or more shared boundaries;
combining the terminated sets in one model space.

14. The system of claim 10, wherein an edge is determined to be between two horizons if vertical lines extending in both directions from the edge each intersect one of the two horizons.

15. The system of claim 14, wherein an edge is determined to be inside a boundary of an adjacent horizon if a vertical line extending in either direction from the edge intersects the adjacent horizon.

16. The system of claim 10, wherein an edge of a given horizon is determined to be between two horizons if lines extending from the edge in both directions normal to the given horizon each intersect one of the two horizons.

17. The system of claim 16, wherein an edge of a given horizon is determined to be inside a boundary of an adjacent horizon if a line extending from the edge in a direction normal to the given horizon intersects the adjacent horizon.

18. The system of claim 10, wherein the set of conformable horizons is an ordered sequence, wherein said performing proportional extrapolation includes iterating through the sequence, and wherein said performing thickness extrapolation includes a separate iteration through the sequence.
